(19) United States
(12) Patent Application Publication
(10) Pub. No.: US 2019/0098390 A1
(43) Pub. Date: Mar. 28, 2019

(54) Earbuds With Capacitive Sensors

(71) Applicant: Apple Inc., Cupertino, CA (US)

(72) Inventors: Marc-Angelo P. Carino, Los Angeles, CA (US); Gareth J. Powell, Culver City, CA (US); Chen Na, Cerritos, CA (US)

(21) Appl. No.: 16/017,888

(22) Filed: Jun. 25, 2018

Related U.S. Application Data
(60) Provisional application No. 62/562,982, filed on Sep. 25, 2017.

(51) Int. Cl. H04R 1/10; H04R 5/04; H04R 5/033

(52) U.S. Cl. CPC H04R 1/1016; H04R 1/105; H04R 1/1041; H04R 2400/01; H04R 5/033; H04R 2420/07; H04R 2201/109; H04R 5/04

(57) ABSTRACT

An earbud may include capacitive sensor electrodes and a capacitance-to-digital converter that is configured to make capacitance measurements with the capacitive sensor electrodes. The earbud may have a housing in which a speaker is mounted. A tubular portion of the housing may have a passageway that is aligned with the speaker. The tubular portion may be received within the ear canal of a user. The tubular portion may include a tubular member on which the capacitive sensor electrodes are formed. The tubular member may be formed from a compressible tubular member that is compressed when the earbud is worn in the ear of the user. Ring-shaped electrodes and other electrodes may be formed on the compressible tubular member. Control circuitry in the earbud may determine whether the earbud is fully or partially within the ear of a user based on the capacitance measurements.

This application claims the benefit of provisional patent application No. 62/562,982, filed Sep. 25, 2017, which is hereby incorporated by reference herein in its entirety.

### BACKGROUND

This relates generally to electronic devices, and, more particularly, to wearable electronic devices such as earbuds.

Cellular telephones, computers, and other electronic equipment may generate audio signals for media playback operations and telephone calls. Speakers in these electronic devices may be used to play audio for a user. Accessories such as earbuds may also be used to play audio for a user. Earbuds and other devices with speakers may contain audio processing circuitry and communications circuitry. Some earbuds contain batteries to support wireless operation.

It can be challenging to control the operation of devices such as earbuds. For example, it may be difficult or impossible to automatically adjust the operation of an earbud to reduce power for extended battery life or to dynamically adjust media playback.

### SUMMARY

An electronic device such as an earbud may have sensor circuitry. The sensor circuitry may include capacitive sensor electrodes and a capacitance-to-digital converter that is configured to make capacitance measurements with the capacitive sensor electrodes. Control circuitry in the earbud may use the capacitance measurements to determine whether the earbuds are being worn by a user. The control circuitry may also use the capacitance measurements to determine whether earbuds are fully or partly inserted within a user's ear. Based on these determinations, the control circuitry can take suitable action such as adjusting audio playback settings and activating electrical components or placing unneeded components in a low-power sleep mode.

An earbud may have a housing in which a speaker is mounted. A tubular portion of the housing may have a passageway that is aligned with the speaker. The tubular portion may be configured to be received within the ear canal of a user.

The tubular portion may include a tubular member on which the capacitive sensor electrodes are formed. The tubular member may be formed from a compressible tubular member that is compressed when the earbud is received within the ear of the user. In some configurations, the tubular member may have a rigid inner tube surrounded by a compressible outer tube. Ring-shaped electrodes and other electrodes may be formed on the tubular member. A flexible printed circuit may have metal traces that form the electrodes.

### BRIEF DESCRIPTION OF THE DRAWINGS

FIG. 1 is a schematic diagram of an illustrative system with earbuds in accordance with an embodiment.

FIG. 2 is a perspective view of an illustrative earbud in accordance with an embodiment.

FIG. 3 is a side view of an illustrative earbud in an ear of a user in accordance with an embodiment.

FIGS. 4 and 5 are diagrams of illustrative sensing circuits in accordance with embodiments.

FIG. 6 is a diagram of an illustrative earbud in accordance with an embodiment.

FIG. 7 is a flow chart of illustrative operations involved in operating earbuds in accordance with an embodiment.

FIG. 8 is a perspective view of an illustrative compressible tubular member with coaxial inner and outer capacitive sensor electrodes in accordance with an embodiment.

FIG. 9 is a cross-sectional view of the tubular member of FIG. 8 in accordance with an embodiment.

FIGS. 10, 11, 12, and 13 are perspective views of illustrative tubular members with sensor electrodes in accordance with an embodiment.

FIG. 14 is a front view of an illustrative flexible printed circuit with metal traces for forming sensor electrodes in accordance with an embodiment.

FIG. 15 is a perspective view of an illustrative tubular member being wrapped with a flexible printed circuit having sensor electrodes in accordance with an embodiment.

FIG. 16 is a diagram of an illustrative ground structure with crisscrossed lines that may be incorporated into a flexible printed circuit in accordance with an embodiment.

FIG. 17 is a cross-sectional side view of an illustrative earbud in accordance with an embodiment.

### DETAILED DESCRIPTION

Electronic devices may have components such as speakers for presenting audio to a user. The electronic devices may be wearable devices such as earbuds. The earbuds may be worn in the ears of a user.

Sensors may be used in earbuds to gather input from a user and from the environment. For example, capacitive sensors may be formed on tubular earbud structures that are configured to be received within a user's ears. Control circuitry and capacitance-to-digital converter circuitry in the earbuds can use the electrodes to gather capacitance measurements. The capacitance measurements can be used to determine whether the earbuds are being worn by a user and whether the earbuds are fully or partially inserted in the user's ear. Capacitive sensors may be used as stand-alone sensors in the earbuds or may be used in conjunction with other earbud sensors such as resistive sensors, optical proximity sensors, strain gauges, and/or other sensors.

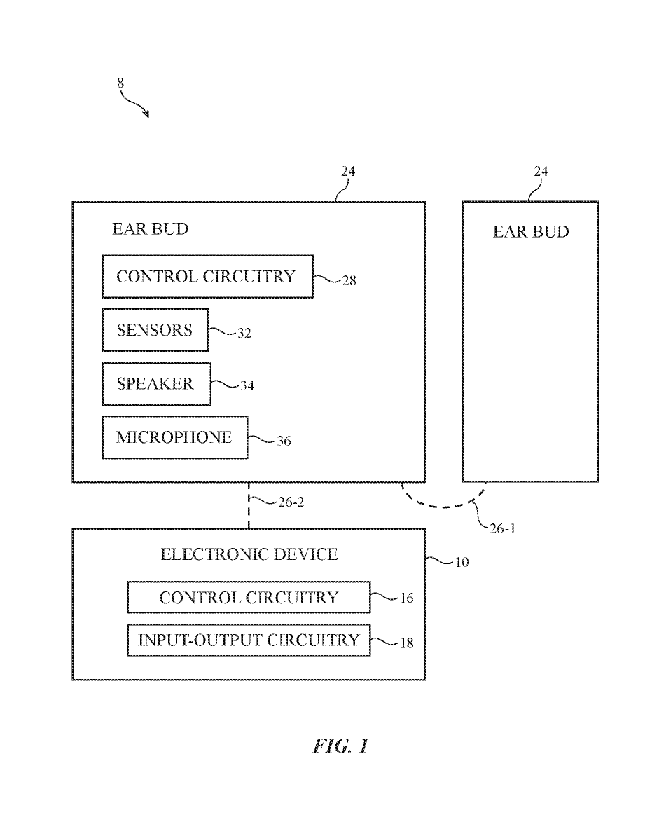

A schematic diagram of an illustrative system with electronic devices such as earbuds is shown in FIG. 1. As shown in FIG. 1, system 8 may contain a pair of earbuds 24 (e.g., left and right earbuds for a user's left and right ears). If desired, earbuds 24 may communicate with each other using a cable or wirelessly, as illustrated by path 26-1. When a cable is used to join earbuds 24, the cable may help hold earbuds 24 to each other. Earbuds 24 may have a cable that plugs into a host device such as electronic device 10 and/or may have wireless communications circuitry for communicating wirelessly with device 10. Wired and/or wireless connections such as these are illustrated as path 26-2 in FIG. 1.

Host electronic device 10 may be a cellular telephone, may be a computer, may be a wristwatch device or other wearable equipment, may be part of an embedded system (e.g., a system in a plane or vehicle), may be part of a home network, or may be any other suitable electronic equipment.

As shown in FIG. 1, earbuds 24 and electronic device 10 may have control circuitry 28 and 16. Control circuitry 28 and 16 may include storage and processing circuitry for supporting the operation of earbuds 24 and device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 28 and 16 may be used to control the operation of the equipment of system 8. The processing circuitry may be based on one or more microprocessors, microcontrollers, digital signal processors, baseband processors, power management units, audio chips, application specific integrated circuits, etc.

Device 10 may have input-output circuitry 18. Input-output circuitry 18 may include wired communications circuitry and wireless communications circuitry (e.g., radio-frequency transceivers) for supporting communications with wearable devices such as earbuds 24 or other wireless wearable electronic devices via wired and/or wireless links. Earbuds 24 may have wireless communications circuitry in control circuitry 28 for supporting communications with the wireless communications circuitry of device 10. Earbuds 24 may also communicate with each other using wireless circuitry.

Input-output circuitry 18 may be used to allow data to be supplied to device 10 and to allow media and other data to be provided from device 10 to external devices such as earbuds 24. Input-output devices in circuitry 18 may include buttons, joysticks, scrolling wheels, touch pads, key pads, keyboards, microphones, speakers, displays (e.g., touch screen displays), tone generators, vibrators (e.g., piezoelectric vibrating components, etc.), cameras, sensors, light-emitting diodes and other status indicators, data ports, etc. A user can control the operation of device 10 by supplying commands through the input-output devices and may receive status information and other output from device 10 using the output resources of input-output devices. If desired, some or all of these input-output devices may be incorporated into earbuds 24.

Each earbud 24 may have one or more sensors 32 (e.g., capacitive sensors, optical proximity sensors that include light-emitting diodes for emitting infrared light or other light and that include light detectors that detect corresponding reflected light, temperature sensors, force sensors, resistive sensors, pressure sensors, magnetic sensors, strain gauges, gas sensors, ambient light sensors, sensors for measuring position and/or orientation such as accelerometers, compasses, and/or gyroscopes, etc.). Each earbud 24 may also have additional components such as speaker 34 and microphone 36. Speakers 34 may supply sound to the ears of a user. Microphones 36 may gather audio data such as the voice of a user who is making a telephone call and/or ambient noise information (e.g., for noise cancellation).

If desired, an accelerometer in earbuds 24 may detect when earbuds 24 are in motion or are at rest. During operation of earbud 24, a user may supply tap commands (e.g., double taps, triple taps, other patterns of taps, single taps, etc.) that are detected by an accelerometer to control the operation of earbuds 24. Buttons and other devices may also be used in gathering user input.

Earbuds 24 may use capacitive sensors that gather capacitive sensor readings (e.g., capacitive proximity sensor readings and/or capacitive force sensor readings) and other sensors that gather sensor readings to determine whether earbuds 24 are being worn by a user. This data may be gathered when processing tap commands to avoid false tap detections. Information from these sensors and/or other sensors may also be used in determining the current operating mode of earbuds 24 (e.g., whether earbuds 24 are stowed in a case, are at rest on a table, are in one or both ears of a user, are being handled by a user, are fully or partly inserted into one or both ears of the user, etc.). Information on the current operating mode of the earbuds may be used in adjusting audio playback settings such as equalizer settings, controlling power management functions (e.g., placing earbuds 24 in a low power sleep mode when not in use to play audio for a user), and/or taking other suitable actions in system 8.

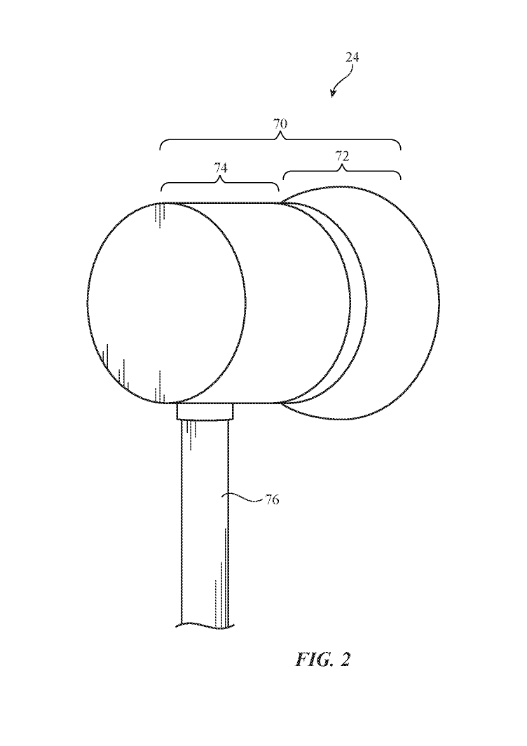

FIG. 2 is a perspective view of an illustrative electronic device such as an earbud. As shown in FIG. 2, earbud 24 may include a housing such as housing 70. Control circuitry 28 and other components of earbud 24 may be mounted in housing 70. Housing 70 may have walls formed from plastic, metal, ceramic, glass, sapphire or other crystalline materials, fiber-based composites such as fiberglass and carbon-fiber composite material, natural materials such as wood and cotton, other suitable materials, and/or combinations of these materials. Housing 70 may have a portion such as portion 74 that houses speaker 34 and a portion such as portion 72 that is configured to be inserted into the ear of a user. Portion 72 may be a tubular portion having a tubular shape with a hollow central sound passageway surrounded by rigid and/or compressible materials (e.g., elastomeric polymer, foam, rigid polymer, etc.). During operation, sound from speaker 34 may pass through the hollow passageway in portion 72 to the user's ear canal.

Portion 72 may have compressible tubular structures that allow earbud 24 to be inserted into a user's ear and worn comfortably within the user's ear. Optional cable 76 may be used to route signals between device 10 and earbud 24. In configurations in which cable 76 is omitted, signals can be conveyed between device 10 and earbud 24 wirelessly and/or earbud 24 can be used as a stand-alone device.

FIG. 3 is a cross-sectional side view of an illustrative earbud being worn by a user. As shown in FIG. 3, earbud 24 may be inserted into ear 50 so that portion 72 is compressed and fits snugly within ear canal 48. Capacitive sensors in portion 72 can be used to form a force sensor to measure the amount of compression of portion 72 (e.g., to measure compressive force on portion 72) and/or can be used to form a proximity sensor or a touch sensor that measures contact between portion 72 and the surfaces of ear canal 48.

In force sensor configurations, force measurements are made based on the principal that the capacitance between a set of capacitance electrodes (e.g., parallel plates) is proportional to the distance separating the electrodes. Compressible material such as foam, elastomeric polymer material such as silicone, or other compressible material can be used in portion 72 (e.g., to form a compressible tube). Electrodes can be formed on the inner and outer surfaces of the tube. By monitoring the capacitance between the electrodes, the amount of force exerted on earbud 24 (portion 72) can be measured.

In proximity and touch sensor configurations, projected electric fields between capacitive sensor electrodes may be affected by the presence of a user's ear canal adjacent to the electrodes. The output from a capacitive sensor of this type serves to indicate whether ear bud 24 (portion 72) is touching the user's ear and is therefore being worn by the user. If desired, earbud 24 can contain capacitive sensors of multiple types (e.g., force, proximity, and/or touch).

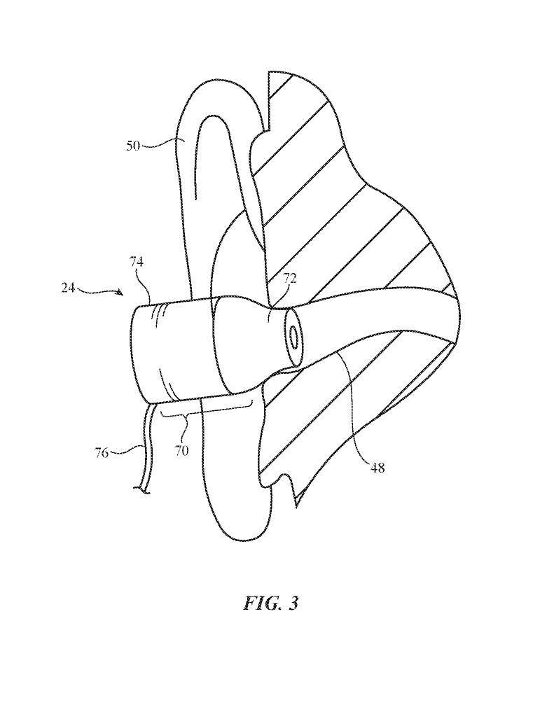

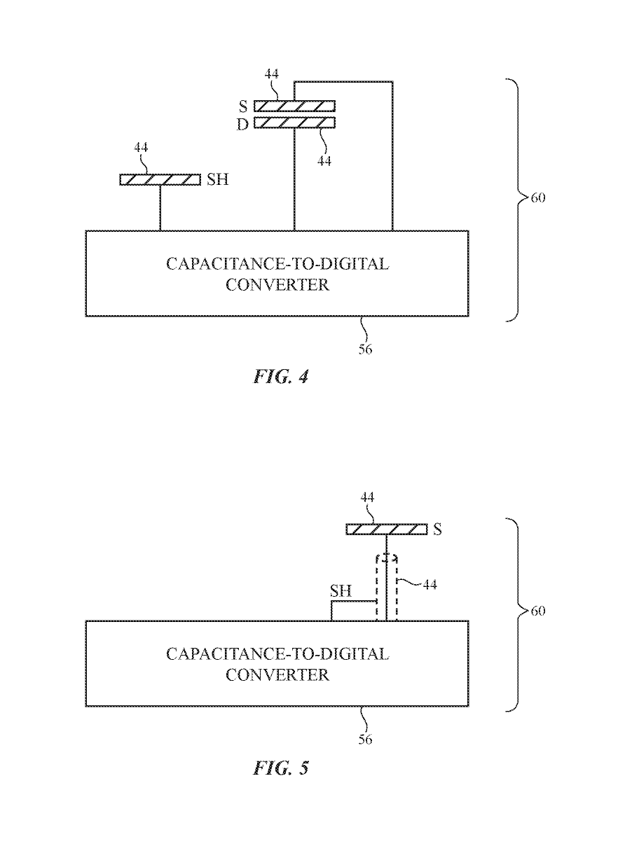

If desired, shield electrodes may be used in the capacitive sensors of earbuds 24. Shield electrodes may be used, for example, in configurations in which it is desirable to shield other electrodes from potential sources of signal noise. Illustrative capacitive sensor configurations with optional shield electrodes that may be used for the capacitive sensors of earbuds 24 are shown in FIGS. 4 and 5. In the example of FIG. 4, capacitive sensor 60 includes electrodes 44 such as sense electrode S, drive electric D, and optional shield electrode SH. Capacitance-to-digital converter 56 gathers capacitance readings using electrodes 44 and supplies corresponding digitized capacitive sensor output to control circuitry 28. Capacitive sensor 60 of FIG. 4, which may sometimes be referred to as a touch mode sensor, may be used to gather self-capacitance or mutual capacitance measurements. When the capacitance between electrodes 44 is measured as electrodes 44 are compressed towards each other by an applied force, capacitive sensor 60 may be referred to as a force sensor. Capacitive sensor 60 of FIG. 5, which may sometimes be referred to as a proximity mode sensor, has electrodes 44 such as sense electrode S and shield SH (e.g., a shield that shields part of the signal path for sense electrode S).

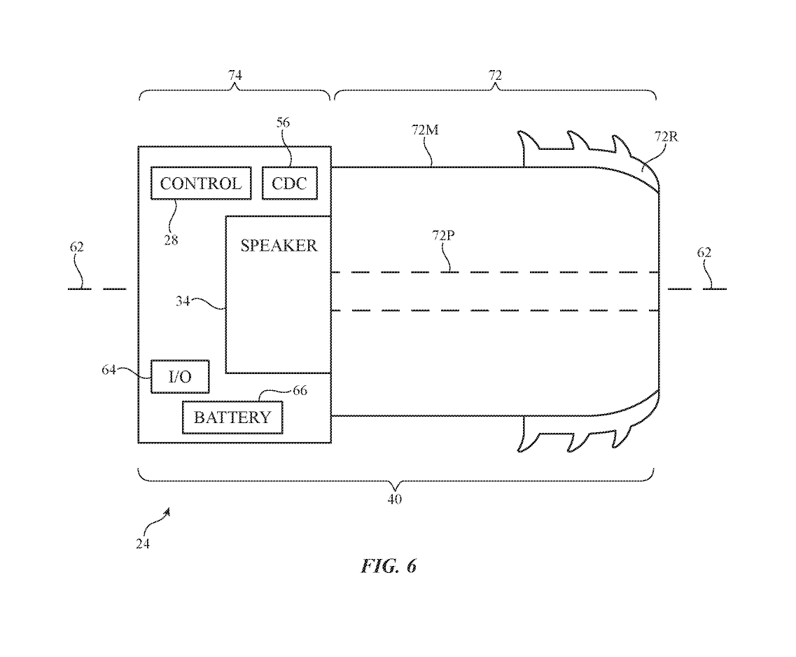

FIG. 6 is a cross-sectional side view of earbud 24 in an illustrative configuration in which portion 72 includes a tubular member 72M and a removable elastomeric sleeve 72R (e.g., a silicone sleeve with protrusions that facilitate insertion and retention of portion 72 in a user's ear canal). Tubular member 72M may have a hollow passageway such as passageway 72P. Speaker 34 may be aligned with an end of passageway 72P. Passageway 72P may run along longitudinal axis 62 of earbud 24 and may allow sound to pass to a user's ear canal from speaker 34. Control circuitry 28, capacitance-to-digital converter 60, input-output circuitry 64, and battery 66 may be housed within housing portion 74 of housing 70. Input-output circuitry 64 may include sensors 32, microphone 36, and/or other electrical components.

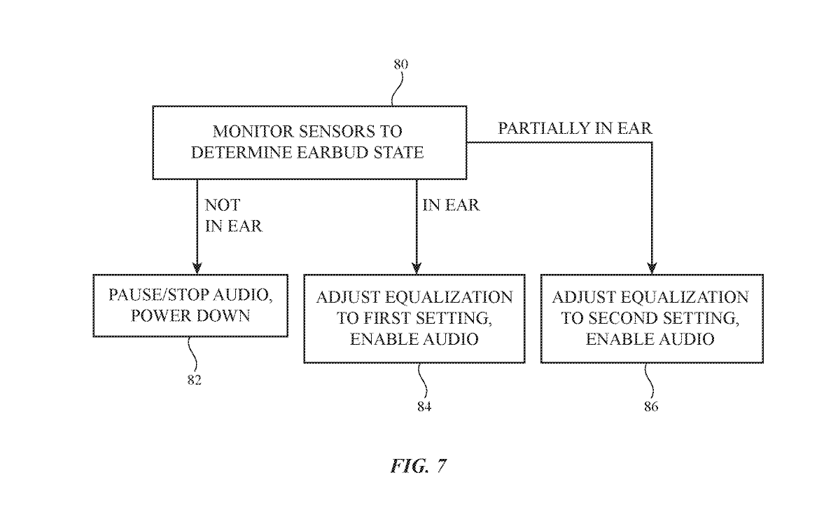

FIG. 7 is a flow chart of illustrative operations involved in using earbuds 24 of system 8. As shown in FIG. 7, earbuds 24 may, during the operations of block 80, use capacitive sensor 60 to gather capacitance measurements. The capacitance measurements may be used in determining whether earbuds 24 are in the ears of a user (and being worn by the user) or are out of the user's ears (e.g., resting on a tabletop or in a case or otherwise not being worn by the user). The capacitance measurements may also be used to determine whether earbuds that are being worn by a user are fully or partly within the user's ear (e.g., snugly or loosely inserted in ear canal 48).

In response to determining that earbuds 24 are not being worn by the user, appropriate action can be taken by system 8 during the operations of block 82. As an example, media playback may be paused (stopped), some or all of the circuitry of earbuds 24 may be turned off or placed in a low-power sleep mode, audio playback may be switched to speakers located elsewhere in system 8, and/or other suitable action can be taken.

In response to determining that earbuds 24 are being worn by a user, system 8 may enable audio playback (e.g., for a telephone call, music playback, etc.) and may, if desired, adjust equalization settings (treble, bass, etc.) and/or other settings appropriately depending on whether earbud(s) 24 are fully in the user's ear (see, e.g., the operations of block 84) or partly within the user's ear (see, e.g., the operations of block 86). When earbuds 24 are only partially inserted into a user's ear, bass reproduction may not be as satisfactory as when earbuds 24 are fully inserted into a user's ear. Accordingly, system 8 (e.g., device 10 and/or earbuds 24) may boost bass frequencies in played back audio to compensate whenever it is determined that earbuds 24 are only partly inserted into a user's ear. If desired, other actions can be taken based on the capacitance measurements made with capacitive sensors 60. The operations of FIG. 7 are illustrative.

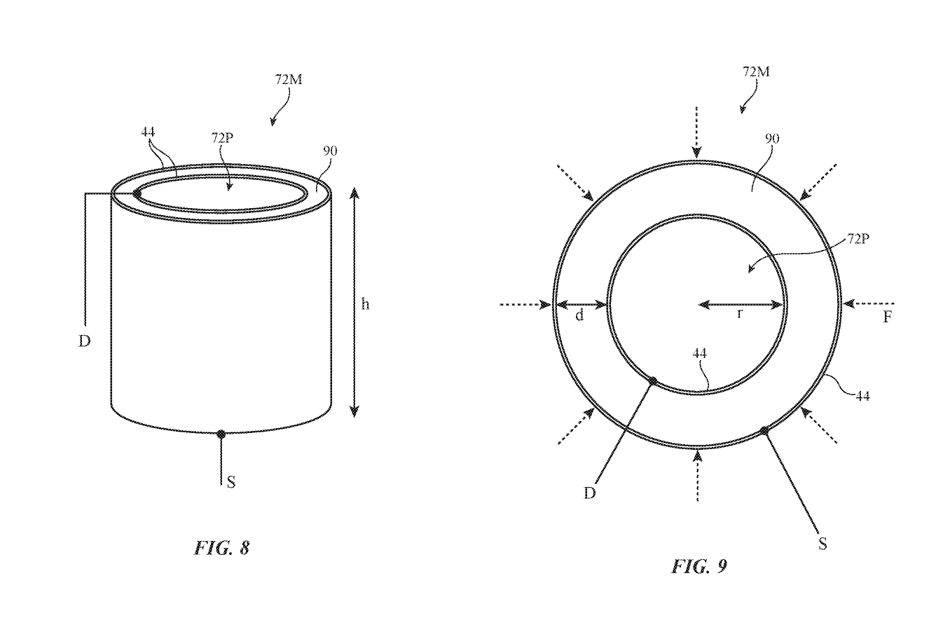

FIG. 8 is a perspective view of tubular member 72M in an illustrative configuration in which member 72M has capacitive force sensor electrodes 44. As shown in FIG. 72, member 72M may have a hollow passageway such as passageway 72P that passes through the center of tubular member 72M and that is coaxial with tubular member 72M. Sound may travel through passageway 72P during use of earbud 24. Tubular member 72M may be a compressible tubular member formed from a compressible material such as foam, elastomeric polymer such as silicone, or other compressible tubular structures. Tubular member 72M may be characterized by a height h of about 0.5-20 mm, at least 2 mm, at least 4 mm, less than 15 mm, less than 10 mm, or other suitable height (length along the longitudinal axis of tubular member 72M). A first electrode 44 (e.g., a drive electrode D) may be formed on the inner surface of tubular member 72M within passageway 72P. An opposing coaxial second electrode 44 (e.g., a concentric sense electrode S) may be formed on the opposing outer surface of tubular member 72M.

FIG. 9 is a cross-sectional view of tubular member 72M showing how tubular member 72M may be characterized by a thickness d and radius r. Thickness d may be, for example, 0.05 mm to 4 mm, at least 0.1 mm, at least 0.3 mm, at least 0.7 mm, at least 1 mm, at least 1.5 mm, at least 2 mm, less than 5 mm, or other suitable thickness. Radius r may be, for example, 1-8 mm, at least 0.5 mm, at least 1.5 mm, less than 8 mm, less than 6 mm, etc.

When force F is applied to one or more sides of member 72M, the spacing d between electrodes 44 decreases (at least locally) and measured capacitance rises (e.g., the structures of FIGS. 8 and 9 may be used as a capacitive force sensor).

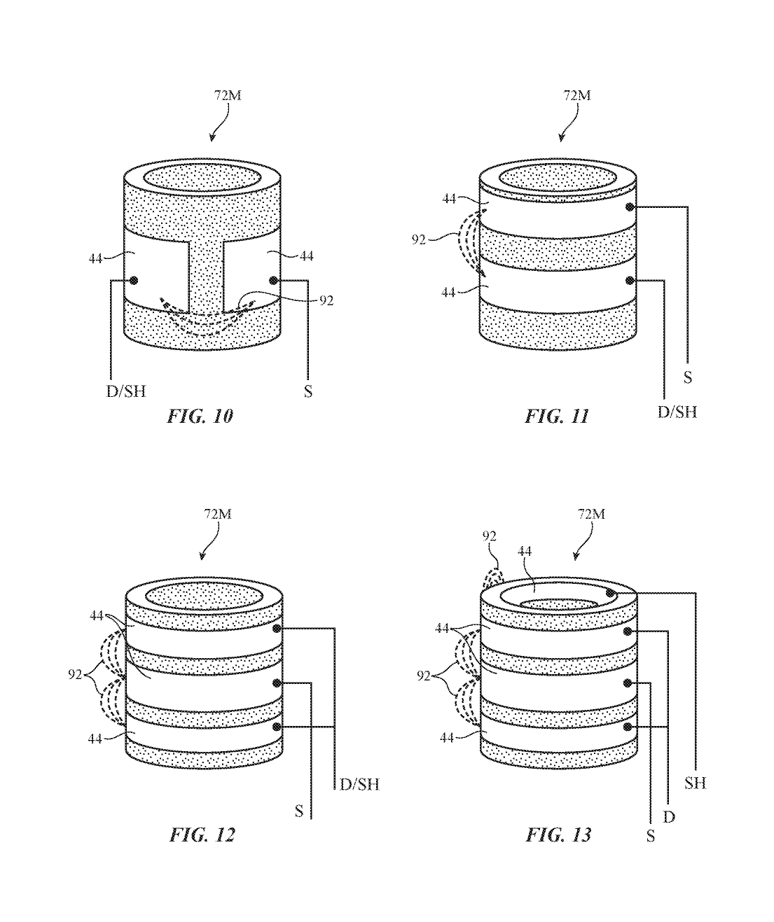

Illustrative capacitive sensor arrangements based on projected fields (e.g., touch or proximity sensor configurations) are shown in FIGS. 10, 11, 12, and 13. As shown in FIG. 10, electrodes 44 may have semicircular (horseshoe) shapes. Each electrode 44 may have end portions that are separated by a gap that runs parallel to the longitudinal axis of tubular member 72M. During operation, electric fields 92 may span the gap to sense the presence of a user's ear. Partial ring arrangements of the type shown in FIG. 10 may be used to provide space for signal lines (e.g., metal traces) that extend along the length of tubular member 72M.

In the examples of FIGS. 11, 12, and 13, electrodes 44 have ring shapes and electric fields 92 extend between the rings. In this type of arrangement, ring-shaped metal traces may wrap around the outer circumference of tubular member 74, so that passageway 72P passes through each of these rings. FIG. 13 shows how a ring-shaped metal traces (e.g., a metal ring used as an inner shield) may cover the inner surface of tubular member 72M. If desired, inner shields such as the inner shield electrode of FIG. 13 may be used with electrode arrangements of the types shown in FIGS. 10, 11, and 12. Other electrodes arrangements may also be used. The configurations of FIGS. 10, 11, 12, and 13 are illustrative.

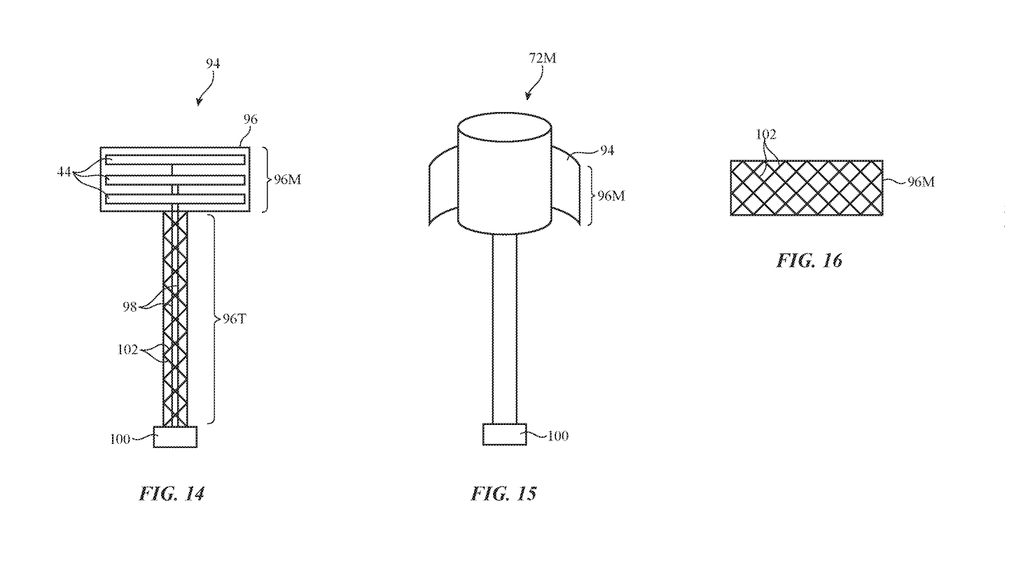

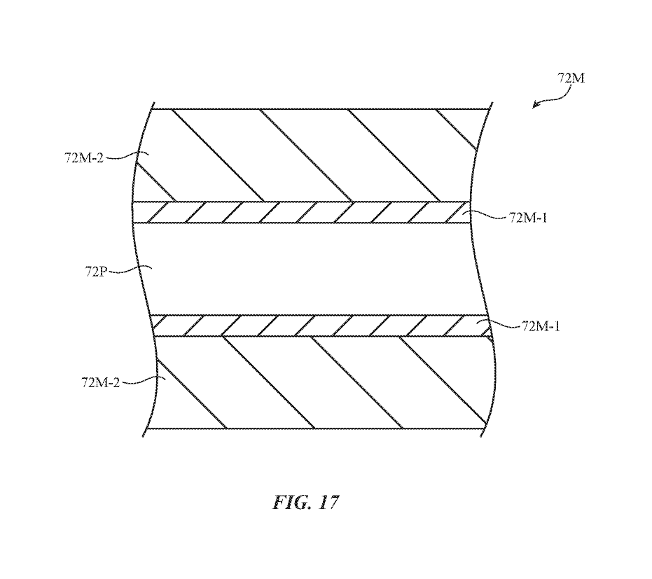

Metal traces for electrodes 44 can be deposited and patterned directly on tubular member 72M or can be formed on a substrate such as a printed circuit that is mounted to tubular member 72M (e.g., using adhesive). FIGS. 14, 15, and 16 are diagrams showing how a flexible printed circuit can be used in forming electrodes 44. As shown in FIG. 14, electrodes 44 can be formed from metal traces on printed circuit substrate 96 of flexible printed circuit 94. Connector 100 may be used to couple printed circuit 94 to another printed circuit. Flexible printed circuit substrate 96 may be formed from a sheet of polyimide or other flexible polymer layer(s). Metal traces that are coupled to electrodes 44 on main portion 96M of substrate 96 may form signal lines 98 that extend along tail portion 96T of substrate 96 and may mate with terminals in connector 100. FIG. 15 shows how main portion 96M of flexible printed circuit 94 can be wrapped around tubular member 72M (e.g., to form horseshoe electrodes of the type shown in FIG. 10). Adhesive, screws, or other attachment mechanisms may be used in coupling flexible printed circuit 94 to tubular member 72M. A cross-hatched ground plane or other ground structures may be included in flexible printed circuit 94. The cross-hated ground plane may be used for a shield in tail portion 96T as shown by crisscrossed lines 102 of FIG. 14 and/or for a shield in main portion 94M of flexible printed circuit 94 as shown by crisscrossed lines 102 in FIG. 16.

If desired, tubular member 72M may be formed from multiple portions such as inner tubular portion 72M-1 of FIG. 17 (e.g., a rigid polymer tube) and outer tubular portion 72M-2 of FIG. 17 (e.g., an elastomeric polymer tube, a foam tube, or a tube of other compressible material.). Electrodes 44 may be formed on the outer surface of tubular portion 72M-2, may be formed on the inner surface of tubular portion 72M-1, may be formed on the outer surface of tubular portion 72M-1, and/or may be formed on the inner surface of tubular portion 72M-2.

If desired, multiple types of sensor may be used in earbuds 24. For example, in addition to incorporating capacitive sensor 60 into earbud 24, earbud 24 may be provided with a resistive force sensor (e.g., a force sensor formed by monitoring the resistance of a foam material or other material that forms member 72M as member 72M is compressed during insertion in a user's ear canal), a strain gauge (e.g., a strain gauge formed on flexible printed circuit substrate 96 and/or directly on member 72M, optical sensors (e.g., an optical proximity sensor that emits infrared light or other light and that detects this light after reflection from a user's ear), and/or other types of sensor.

The foregoing is merely illustrative and various modifications can be made to the described embodiments. The foregoing embodiments may be implemented individually or in any combination.

What is claimed is:

1. An earbud, comprising:
a housing having a tubular portion with a passageway;
a speaker in the housing that is aligned with the passageway and that is configured to provide sound through the passageway;
capacitive sensor electrodes on the tubular portion; and
a capacitance-to-digital converter configured to gather capacitive sensor measurements from the capacitive sensor electrodes.

2. The earbud defined in claim 1 wherein the tubular portion comprises a compressible tubular member.

3. The earbud defined in claim 2 wherein the capacitive sensor electrodes include a first capacitive sensor electrode on an outer surface of the tubular portion and a second capacitive sensor electrode on an inner surface of the tubular member that runs along the passageway.

4. The earbud defined in claim 1 wherein the capacitive sensor electrodes include a metal ring that surrounds the passageway.

5. The earbud defined in claim 1 wherein the capacitive sensor electrodes include a partial metal ring that partially surrounds the passageway and that has end portions separated by a gap that extends parallel to the passageway.

6. The earbud defined in claim 1 wherein the capacitive sensor electrodes include multiple rings arranged respectively at different positions along the tubular portion.

7. The earbud defined in claim 1 further comprising control circuitry configured to determine from the capacitive sensor measurements whether the tubular portion is in an ear canal.

8. The earbud defined in claim 7 wherein the control circuitry is configured to adjust an audio equalization setting based on the capacitive sensor measurements.

9. An earbud, comprising:
a tubular member that extends along a longitudinal axis, wherein the tubular member has a passageway that passes through the tubular member along the longitudinal axis;
a speaker that is aligned with the passageway and that is configured to supply sound through the passageway; and
first and second metal rings supported by the tubular member that form respective first and second capacitive sensor electrodes.

10. The earbud defined in claim 9 further comprising:
a capacitance-to-digital converter configured to use the first and second metal rings to gather capacitive sensor measurements; and
control circuitry configured to play audio through the speaker and configured to adjust an equalization setting for the audio based on the capacitive sensor measurements.

11. The earbud defined in claim 9 wherein the tubular member comprises a compressible material.

12. The earbud defined in claim 11 wherein the compressible material comprises foam.

13. The earbud defined in claim 9 wherein the tubular member has a rigid inner tubular portion and a compressible outer tubular portion surrounding the rigid inner tubular portion.

14. The earbud defined in claim 9 wherein the first metal ring is formed within the passageway and wherein the second metal ring is coaxial with the first metal ring.

15. The earbud defined in claim 9 further comprising a flexible printed circuit with metal traces, wherein the first and second capacitive sensor electrodes are formed from the metal traces.

16. The earbud defined in claim 15 wherein the flexible printed circuit has a portion that wraps around the tubular member and the longitudinal axis.

17. An electronic device, comprising:
a compressible member configured to be received within an ear of a user, wherein the compressible member includes a passageway;
a speaker configured to provide sound through the passageway;
ring-shaped capacitive sensor electrodes on the compressible electrode; and
a capacitance-to-digital converter that is configured to gather capacitance measurements from the capacitive sensor electrodes.

18. The electronic device defined in claim 17 wherein the passageway passes through each of the ring-shaped capacitive sensor electrodes.

19. The electronic device defined in claim 18 wherein the compressible member comprises a foam tube.

20. The electronic device defined in claim 19 further comprising a rigid polymer tube within the foam tube.
